(19) United States
(12) Patent Application Publication
(10) Pub. No.: US 2013/0151243 A1
(43) Pub. Date: Jun. 13, 2013

(54) VOICE MODULATION APPARATUS AND VOICE MODULATION METHOD USING THE SAME

(71) Applicant: Samsung Electronics Co., Ltd., Suwon-si (KR)

(72) Inventors: Sang-deok KIM, Suwon-si (KR); Sang-rae LEE, Cheongju-si (KR); Jong-jik LEE, Suwon-si (KR)

(73) Assignee: SAMSUNG ELECTRONICS CO., LTD., Suwon-si (KR)

(21) Appl. No.: 13/708,389

(22) Filed: Dec. 7, 2012

(30) Foreign Application Priority Data
Dec. 9, 2011 (KR) 2011-0132020

(51) Int. Cl. G10L 21/003

(52) U.S. Cl. CPC G10L 21/003
USPC 704/201; 704/258

(57) ABSTRACT

A voice modulation apparatus is provided. The voice modulation apparatus includes an audio signal input unit which receives an audio signal from an external source; an extraction unit which extracts property information relating to a voice from the audio signal; a storage unit which stores the extracted property information; a control unit which modulates a target voice based on the extracted property information; and an output unit which outputs the modulated target voice.

### CROSS-REFERENCE TO RELATED APPLICATION(S)

This application claims priority under 35 U.S.C. §119 from Korean Patent Application No. 10-2011-0132020, filed on Dec. 9, 2011, in the Korean Intellectual Property Office, the disclosure of which is incorporated herein by reference in its entirety.

### BACKGROUND

1. Field

The present general inventive concept generally relates to a voice modulation apparatus and a voice modulation method using the same, and more particularly, to a voice modulation apparatus to modulate a voice and a voice modulation method using the voice modulation apparatus.

2. Description of the Related Art

Voice modulation apparatuses, which are devices to modulate the voice of a user according to a set of conditions and output the modulated voice, have been widely used in various devices, such as karaoke systems, for example, for fun and excitement purposes.

However, related-art voice modulation apparatuses simply modulate a target voice into only a particular voice. That is, related-art voice modulation apparatuses may not be able to provide a variety of modulated voices and the user may easily become bored.

Therefore, there is a need for methods to modulate the voice of a user in various manners.

### SUMMARY

Exemplary embodiments address at least the above problems and/or disadvantages and other disadvantages not described above. Also, the exemplary embodiments are not required to overcome the disadvantages described above, and an exemplary embodiment may not overcome any of the problems described above.

The exemplary embodiments provide a voice modulation apparatus to modulate the voice of a user to correspond to the voice of a particular person and a voice modulation method using the voice modulation apparatus.

According to an aspect of an exemplary embodiment, there is provided a voice modulation apparatus to modulate a voice of a user, the voice modulation apparatus including: an audio signal input unit which receives an audio signal from an external source; an extraction unit which extracts property information relating to a voice from the audio signal; a storage unit which stores the extracted property information; a control unit which modulates the voice of the user into a target voice based on the extracted property information; and an output unit which outputs the target voice.

The voice modulation apparatus may also include: a voice reception unit which receives the user voice in real time, wherein the control unit modulates the user voice into the target voice in real time based on the extracted property information and outputs the target voice.

The storage unit may store different property information regarding different voices extracted from a plurality of audio signals, wherein the control unit modulates a plurality of user voices into a plurality of target voices based on the different property information.

The external source may include at least one of an MPEG Audio Layer 3 (MP3) player, a Compact Disc (CD) player, and a mobile phone.

The voice modulation apparatus may be a karaoke machine.

According to an aspect of another exemplary embodiment, there is provided a voice modulation method using a voice modulation apparatus to modulate a voice of a user, the voice modulation method including: receiving an audio signal from an external source; extracting property information relating to a voice signal from the audio signal; modulating the voice of the user into a target voice based on the extracted property information; and outputting the target voice.

The voice modulation method may also include: receiving the voice of the user in real time, wherein the modulating comprises modulating the voice of the user in real time based on the extracted property information.

The voice modulation method may also include: storing different property information regarding different voices extracted from a plurality of audio signals, wherein the modulating comprises modulating a plurality of user voices based on the different property information.

The external source may include at least one of an MPEG Audio Layer 3 (MP3) player, a Compact Disc (CD) player, and a mobile phone.

The voice modulation apparatus may be a karaoke machine.

As described above, it is possible to prevent a user of the machine from becoming easily bored by modulating the voice of the user to correspond to the voice of a particular person, received and extracted from an external source.

### BRIEF DESCRIPTION OF THE DRAWINGS

The above and/or other aspects will be more apparent by describing certain exemplary embodiments with reference to the accompanying drawings, in which:

FIG. 1 is a block diagram illustrating a voice modulation apparatus according to an exemplary embodiment;

FIG. 2 is a diagram illustrating an example of a system to which a voice modulation apparatus according to an exemplary embodiment is applied;

FIGS. 3A to 3C are diagrams illustrating an example of User Interfaces (UIs) to select property information to be applied to a target voice from a property information list; and

FIG. 4 is a flowchart illustrating a voice modulation method according to an exemplary embodiment.

### DETAILED DESCRIPTION OF THE EXEMPLARY EMBODIMENTS

Exemplary embodiments are described in greater detail with reference to the accompanying drawings.

In the following description, the same drawing reference numerals are used for the same elements even in different drawings. The matters defined in the description, such as detailed construction and elements, are provided to assist in a comprehensive understanding of the exemplary embodiments. Thus, it is apparent that the exemplary embodiments can be carried out without those specifically defined matters. Also, well-known functions or constructions are not described in detail since they would obscure the exemplary embodiments with unnecessary detail.

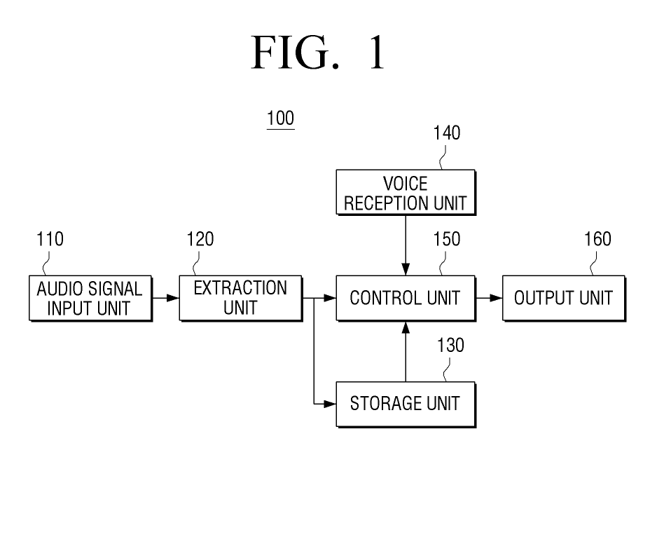

FIG. 1 is a block diagram illustrating a voice modulation apparatus according to an exemplary embodiment. Referring to FIG. 1, a voice modulation apparatus 100 includes an audio signal input unit 110, an extraction unit 120, a storage unit 130, a voice reception unit 140, a control unit 150, and an output unit 160. For example, the voice modulation apparatus 100 may be a karaoke machine.

The audio signal input unit 110 may receive an input audio signal from an external source (not illustrated).

For example, the audio signal input unit 110 may be implemented as a Universal Serial Bus (USB) input port, may be connected to the external source, and may receive various audio signals from the external source.

For example, the external source may include, but is not limited to, at least one of an MPEG Audio Layer 3 (MP3) player, a Compact Disc (CD) player, and a mobile phone. Alternatively, the external source may include at least one device capable of playing media data including voice data. The audio signal input unit 110 may receive a song sung by a particular singer or the voice of a particular person from the external source.

In this exemplary embodiment, the audio signal input unit 110 may be equipped with a USB input port. Alternatively, the audio signal input unit 110 may be equipped with various other input ports than a USB input port in accordance with the type of the external source. For example, the audio signal input unit 110 may be implemented as a stereo jack to receive data from the external source or may be implemented as a communication module capable of wirelessly communicating with the external source, such as a Bluetooth communication module.

The extraction unit 120 may extract property information from the input audio signal.

More specifically, when the input audio signal includes a voice and background music, the extraction unit 120 may extract only the voice from the input audio signal, and may extract property information from the extracted voice.

The sound of an instrument, unlike voice data, may have a belt-shaped spectrum, which corresponds to a multiple of a fundamental frequency, in a frequency domain. Accordingly, the extraction unit 120 may separate the sound of an instrument from background music by using a filter for removing a spectrum corresponding to a multiple of the fundamental frequency.

The extraction unit 120 may separate a voice signal from the input audio signal in various manners according to how the input audio signal is received.

For example, in a case in which the input audio signal is received in a stereo method, the extraction unit 120 may detect a voice signal from the input audio signal by comparing a left audio signal received from a left channel and a right audio signal received from a right channel.

In the case of the stereo manner, the sound of an instrument is divided into two sound data having different properties and the two sound data are output via the left and right channels, respectively, to provide stereo audio data, whereas, for voice data, the same sound data having the same properties are output via the left and right channels. Accordingly, the extraction unit 120 may detect data having the same voice properties (for example, pitch and frequency) from the left audio signal and the right audio signals as a voice signal.

Alternatively, in a case in which the input audio signal is received in a multichannel manner, the extraction unit 120 may separate only a channel from which a voice signal is being input and may separate the voice signal from the input audio signal. That is, in the case of a multi-channel audio signal, different types of audio signals, such as a voice, a melody, an accompaniment, and the like, may be allocated to different channels. Thus, the extraction unit 120 may separate a voice signal from the input audio signal by selecting a particular channel.

The extraction unit 120 may extract property information from the extracted voice signal. More specifically, the extraction unit 120 may extract unique property information of the extracted voice signal, such as frequency, voice type (voiceless/voiced), speed, pitch, etc.

The storage unit 130 may be a storage medium which stores various programs for operating the voice modulation apparatus 100. For example, the storage unit 130 may be implemented as a volatile memory that requires power to maintain the stored information, such as, a Dynamic Random Access Memory (DRAM), a Static Random Access Memory (SRAM), etc., or a nonvolatile memory that can retain the stored information even when not powered, such as a flash memory, a Ferroelectric Random Access Memory (FRAM), Phase-change Random Access Memory (PRAM), etc.

The storage unit 130 may store the property information of the extracted voice signal. More specifically, the storage unit 130 may map a plurality of audio signals with their respective property information and may store the result of the mapping as a table.

For example, when first audio signals and second audio signals are received from the external source, the extraction unit 120 may extract property information from the first audio signals and the second audio signals, respectively. The storage unit 130 may map the property information extracted from the first audio signal with the first audio signal and the property information extracted from the second audio signal with the second audio signal, and may store the result of the mapping.

That is, the storage unit 130 may store property information for different voice signals from different audio signals.

The voice reception unit 140 may receive a user voice in real time. For example, the voice reception unit 140 may be implemented as a microphone (not illustrated), and may be equipped with a microphone jack connected to the microphone. Accordingly, the voice reception unit 140 may receive the user voice in real time.

The control unit 150 may control the general operation of the voice modulation apparatus 100. More specifically, the control unit 150 may control the extraction unit 120 to extract property information of the voice signal received by the audio signal input unit 110 and to store the extracted property information in the storage unit 130.

The control unit 150 may modulate the user voice into a target voice based on property information of the voice signal extracted from the input audio signal. For example, the control unit 150 may modulate the user voice into the target voice by using a voice modulation algorithm.

More specifically, the control unit 150 may sample the user voice at a predetermined sampling frequency, and may modulate both the frequency of the sampled user voice and the frequency of the voice signal extracted from the input audio signal. That is, the control unit 150 may modulate the sampled user voice based on the property information of the voice signal extracted from the input audio signal.

Since the property information of the voice signal extracted from the input audio signal may include frequency, voice type (voiceless/voiced), speed, pitch, etc., the control unit 150 may modulate the user voice into the target voice such that the target voice can coincide with the voice signal extracted from the input audio signal in terms of, for example, speed and pitch.

Accordingly, the user voice may be modulated into the target voice, for example, the voice of a celebrity, such as, a singer, an actor/actress, a comedian, etc.

The control unit 150 may modulate the user voice into the target voice in real time based on the property information of the voice signal extracted from the input audio signal and output the modulated target voice in real time.

That is, the control unit 150 may set the sampling period for the user voice to several milliseconds. Since the period for modulation is also less than several milliseconds, it may take less than several tens of milliseconds to modulate the user voice into the target voice. Accordingly, the control unit 150 may modulate the user voice into the target voice in real time based on the property information present in the storage unit 130 or the property information of the voice signal extracted from the input audio signal.

The control unit 150 may modulate a plurality of user voices into a plurality of target voices based on different property information of different voice signals.

More specifically, when a first user voice to be modulated into a target voice and a second user voice to be modulated into a target voice are simultaneously or sequentially received via the voice reception unit 140, the control unit 150 may modulate the first user voice into the target voice and the second user voice into another target voice separately based on different property information.

For example, when the voice reception unit 140 is equipped with more than one microphone or more than one microphone jack connected to different microphones, the voice reception unit 140 may receive different user voices to be modulated into different target voices.

In this example, the control unit 150 may set property information differently for each of the different user voices to be modulated into different target voices. For example, the control unit 150 may apply first property information to a user voice to be modulated into a target voice received from a first microphone and second property information to a user voice to be modulated into another target voice received from a second microphone. Accordingly, the different user voices may be modulated into other different voices.

The output unit 160 may output a modulated user voice. For example, the output unit 160 may be implemented as an amplifier (not illustrated) or a speaker (not illustrated) and may output a target voice in accordance with property information.

The voice modulation apparatus 100 may also include a display unit (not illustrated) and an input unit (not illustrated). The display unit and the input unit may also be controlled by the control unit 150.

The display unit may display a list of property information for each previously-stored voice. For example, when a plurality of property information is stored in the storage unit 130, the display unit may display a property information list including the plurality of property information.

The input unit may receive a user command. For example, the input unit may receive a user command to control the operation of the voice modulation apparatus 100. The input unit may be equipped with various buttons for receiving a user command.

The input unit may also receive a user command to select, at least one, property information from the property information list displayed on the display unit. The control unit 150 may modulate a user voice into a target voice based on property information selected from the property information list.

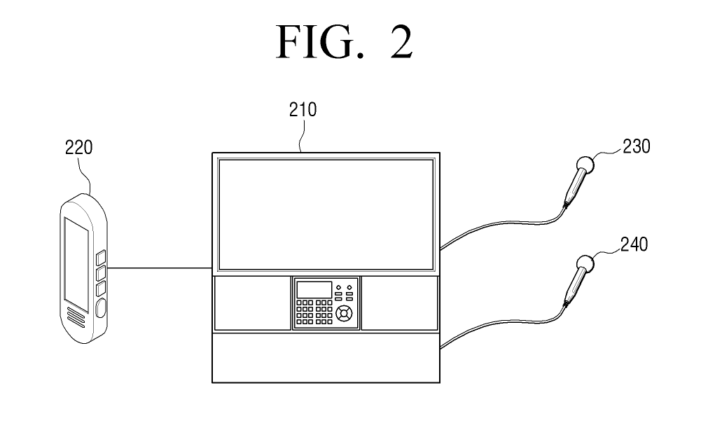

FIG. 2 is a diagram illustrating an example of a system to which a voice modulation apparatus according to an exemplary embodiment is applied. Referring to FIG. 2, a voice modulation apparatus 210 may be implemented as a karaoke machine, and may modulate the user voice based on different property information.

The voice modulation apparatus 210 may receive a plurality of audio signals from an MP3 player 220, may detect property information from each of the audio signals, and may store the detected property information.

A first microphone 230 and a second microphone 240 are connected to the voice modulation apparatus 210. In response to the receipt of the user voice via the first microphone 230 and the second microphone 240, respectively, the voice modulation apparatus 210 may modulate the user voices into the target voices by applying different property information to the user voices received via the first microphone 230 and the second microphone 240.

In the exemplary embodiment illustrated in FIG. 2, the voice of the user may be modulated based on previously-stored property information. Alternatively, when the voice modulation apparatus 210 is connected to a plurality of external devices (not illustrated) and receives a plurality of audio signals from the plurality of external devices, respectively, the voice modulation apparatus 210 may detect property information from each of the plurality of audio signals, and may modulate a plurality of user voices into target voices (for example, the voices of different users) in real time based on the detected property information.

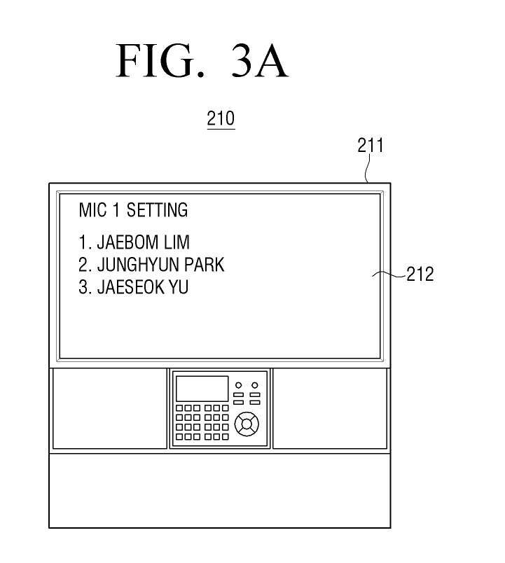

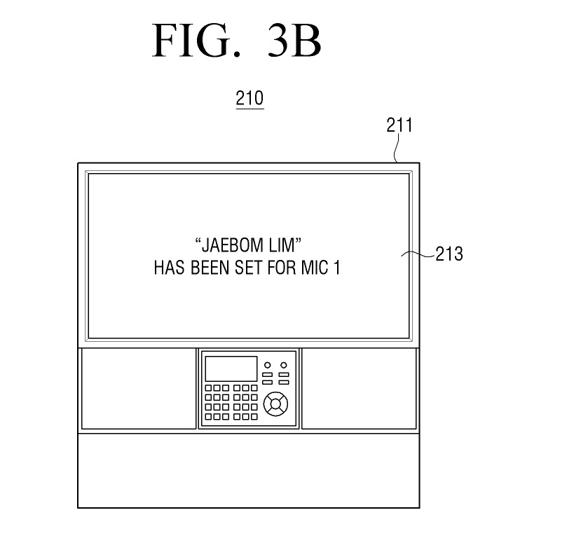

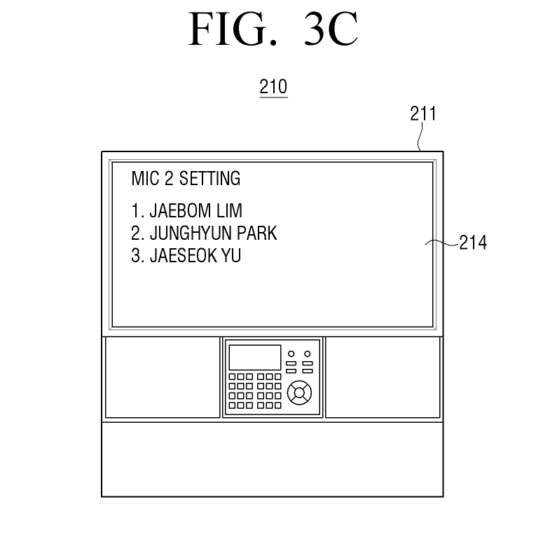

FIGS. 3A to 3C are diagrams illustrating an example of User Interfaces (UIs) that may be provided to select property information to be applied to a user voice modulated to a target voice from a property information list.

Referring to FIGS. 2 and 3A to 3C, a property information list may display a plurality of property information stored in advance in the voice modulation apparatus 210 along with their names. The names of the plurality of property information may be set by a user at the time of the receipt of an audio signal from an external device.

For example, referring to FIG. 3, a display unit 211 of the voice modulation apparatus 210 may display, in accordance with a user command, a property information list 212 including “Jaebom Lim,” “Junghyun Park,” and “Jaeseok Yu” for a target voice received via the first microphone 230.

Referring to FIG. 3B, in response to the selection of an item, for example, “Jaebom Lim,” from the property information list 212 by the user, a confirmation message 213 indicating that “Jaebom Lim” has been chosen may be displayed.

Referring to FIG. 3C, the display unit 211 may display another property information list 214 including “Jaebom Lim,” “Junghyun Park,” and “Jaeseok Yu” for a target voice received via the second microphone 240, and may allow the user to select property information to be applied to the target voice received via the second microphone 230.

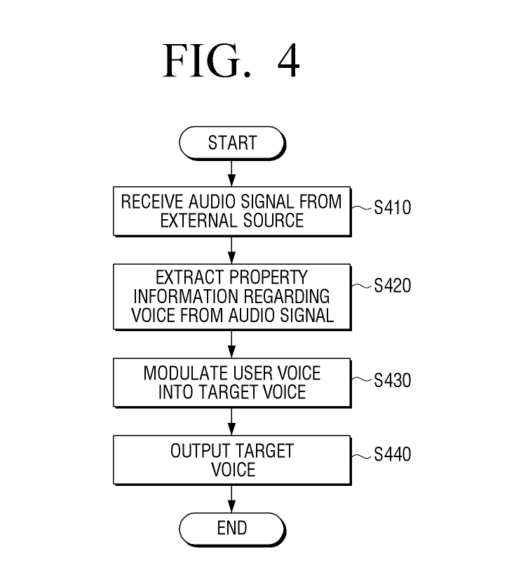

FIG. 4 is a flowchart illustrating a voice modulation method according to an exemplary embodiment, and particularly, an example of a voice modulation method using a voice modulation apparatus that may be implemented as a karaoke machine.

Referring to FIG. 4, in operation S410, an audio signal may be received from an external source.

For example, the external source may include, but is not limited to, at least one of an MP3 player, a CD player, and a mobile phone. Alternatively, the external source may include at least one device capable of playing media data including voice data.

In operation S420, property information may be extracted from the audio signal.

More specifically, when the audio signal includes a voice signal and background music, only the voice signal may be extracted from the audio signal, and property information may be extracted from the extracted voice signal. For example, the property information may include, but is not limited to, unique property information of the extracted voice signal, such as frequency, voice type (e.g., whether voiceless or voiced), speed, pitch, etc.

In operation S430, a user voice may be modulated into a target voice based on the extracted property information. More specifically, the user voice may be modulated into the target voice by using a voice modulation algorithm. The modulation of the user voice into the target voice based on the extracted property information has already been described above, and thus, a detailed description thereof will be omitted.

In operation S440, the modulated target voice may be output.

The voice modulation method illustrated in FIG. 4 may also include receiving the user voice in real time. In this example, in operation S430, the user voice may be modulated into the target voice in real time based on the extracted property information.

The voice modulation method illustrated in FIG. 4 may also include storing different property information extracted from a plurality of audio signals. In this example, in operation S430, a plurality of user voices maybe modulated into a plurality of target voices based on the different property information.

The processes, functions, methods, and/or software described herein may be recorded, stored, or fixed in one or more computer-readable storage media that includes program instructions to be implemented by a computer to cause a processor to execute or perform the program instructions. The media may also include, alone or in combination with the program instructions, data files, data structures, and the like. The media and program instructions may be those specially designed and constructed, or they may be of the kind well-known and available to those having skill in the computer software arts. Examples of computer-readable storage media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules that are recorded, stored, or fixed in one or more computer-readable storage media, in order to perform the operations and methods described above, or vice versa. In addition, a computer-readable storage medium may be distributed among computer systems connected through a network and computer-readable codes or program instructions may be stored and executed in a decentralized manner.

The foregoing exemplary embodiments and advantages are merely exemplary and are not to be construed as limiting. The present teaching can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. A voice modulation apparatus to modulate a voice of a user, the voice modulation apparatus comprising:
an audio signal input unit which receives an audio signal from an external source;
an extraction unit which extracts property information relating to a voice signal from the audio signal;
a storage unit which stores the extracted property information of the voice signal;
a control unit which modulates the voice of the user into a target voice based on the extracted property information of the voice signal; and
an output unit which outputs the target voice.

2. The voice modulation apparatus of claim 1, further comprising:
a voice reception unit which receives the voice of the user in real time,
wherein the control unit modulates the voice of the user into the target voice in real time based on the extracted property information of the voice signal and outputs the target voice.

3. The voice modulation apparatus of claim 1, wherein the storage unit stores different property information regarding different voice signals extracted from a plurality of audio signals,
wherein the control unit modulates a plurality of voices based on the stored different property information regarding the different voice signals extracted from the plurality of audio signals.

4. The voice modulation apparatus of claim 1, wherein the external source comprises at least one of an MPEG Audio Layer 3 (MP3) player, a Compact Disc (CD) player, and a mobile phone.

5. The voice modulation apparatus of claim 1, wherein the voice modulation apparatus is a karaoke machine.

6. A voice modulation method using a voice modulation apparatus to modulate a voice of a user, the voice modulation method comprising:
receiving an audio signal from an external source;
extracting property information relating to a voice signal from the audio signal;
modulating the voice of the user into a target voice based on the extracted property information relating to the voice signal; and
outputting the target voice.

7. The voice modulation method of claim 6, further comprising:
receiving the voice of the user in real time,
wherein the modulating comprises modulating the voice of the user into the target voice in real time based on the extracted property information relating to the voice signal from the audio signal.

8. The voice modulation method of claim 6, further comprising:
storing different property information regarding different voice signals extracted from a plurality of audio signals,
wherein the modulating comprises modulating a plurality of voice signals into a plurality of target voices based on the different property information regarding the different voice signals extracted from the plurality of audio signals.

9. The voice modulation method of claim 6, wherein the external source comprises at least one of an MPEG Audio Layer 3 (MP3) player, a Compact Disc (CD) player, and a mobile phone.

10. The voice modulation method of claim 6, wherein the voice modulation apparatus is a karaoke machine.

11. A voice modulation apparatus comprising:
an audio signal input unit which receives an audio signal including a target voice from an external source;
an extraction unit which extracts property information relating to the target voice;
a storage unit which stores the extracted property information related to the target voice;
a voice reception unit which receives a first voice, different from the target voice, in real time;
a control unit which modulates the first voice into the target voice based on the extracted property information relating to the target voice; and
an output unit which outputs the target voice.

12. The voice modulation apparatus of claim 11, wherein the storage unit stores different property information regarding different voices extracted from a plurality of audio signals,
wherein the control unit modulates a plurality of user voices into a plurality of target voices based on the different property information extracted from the plurality of audio signals.

13. The voice modulation apparatus of claim 11, wherein the external source comprises at least one of an MPEG Audio Layer 3 (MP3) player, a Compact Disc (CD) player, and a mobile phone.

14. The voice modulation apparatus of claim 11, wherein the voice modulation apparatus is a karaoke machine.
